(19) United States
(12) Patent Application Publication
(10) Pub. No.: US 2025/0145886 A1
(43) Pub. Date: May 8, 2025

(54) METHOD OF PREPARING CARBON QUANTUM DOTS (CQDs) FROM WASTE BIOMASS OF A MELON

(71) Applicant: KING FAHD UNIVERSITY OF PETROLEUM AND MINERALS, Dhahran (SA)

(72) Inventors: Firoz KHAN, Dhahran (SA); Masoud AL-RASHEIDI, Dhahran (SA)

(73) Assignee: KING FAHD UNIVERSITY OF PETROLEUM AND MINERALS, Dhahran (SA)

(21) Appl. No.: 18/503,795

(22) Filed: Nov. 7, 2023

(51) Int. Cl. C09K 11/65; B82Y 20/00; B82Y 40/00; C01B 32/15

(52) U.S. Cl. CPC C09K 11/65; C01B 32/15; B82Y 20/00; B82Y 40/00; C01P 2002/72; C01P 2002/82; C01P 2002/84; C01P 2002/85; C01P 2004/03; C01P 2004/04; C01P 2004/64; C01P 2006/60

(57) ABSTRACT

Aspects of the present disclosure are directed to a method for synthesizing carbon quantum dots. The method includes reacting a mixture of a fruit waste material and deionized water hydrothermally in an autoclave at a reaction temperature in a range of 150° C. to 250° C. to form a carbon quantum dot containing suspension, centrifuging the carbon quantum dot containing suspension to separate the carbon quantum dots from a hydrochar, and filtering the carbon quantum dot containing suspension to obtain the carbon quantum dots. The carbon quantum dots have a size ranging from 2 to 10 nm. The carbon quantum dots have a Stokes shift of at least 150 nm at an excitation wavelength of 360 nm or lower.

### STATEMENT OF ACKNOWLEDGEMENT

The inventors acknowledge the support provided by the Interdisciplinary Research Center for Renewable Energy and Power Systems, King Fahd University of Petroleum and Minerals, Saudi Arabia, through project INRE2210.

### BACKGROUND

### Technical Field

The present disclosure is directed to carbon quantum dots (CQDs), particularly to a method of preparing CQDs from melon waste biomass.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

For many decades, carbon-based materials have been considered potential candidates for their application in various fields, such as energy, agriculture, medicine, bio-imaging sensors, engineering, and the like; however, due to the absence of a suitable bandgap in the carbon-based materials, it is difficult for a macroscopic sample of the carbon-based materials to work as an efficient fluorescent material. It is well known that the properties of the material are altered by the reduction of their dimensions within the atomic scale. These materials are recognized as “nanomaterials” (NMs). The nanomaterials with zero dimension (OD) are referred to as “quantum dots” (QDs). The carbon-based QDs (CQDs) have offered a vast range of prospects for the design of materials with diverse properties for numerous uses. Carbon-based NMs are considered cost-effective materials with desirable mechanical strength, tunable electronic properties, and good electrochemical, thermal, and chemical stabilities. Moreover, due to the quantum confinement effect, the CQDs with sizes less than 10 nm act as luminescent materials. CQDs with sizes less than 10 nm have attracted consideration towards advancement owing to their cost-effectiveness, good thermal and chemical stabilities, minimal toxicity, great biocompatibility, easy surface amendments, variable fluorescence, and high photoluminescence quantum yield (PLQY). These properties empower CQDs to have applications in bio-imaging, biologic probes, biomedicine, catalysis, light-emitting diodes (LEDs), solar cells, and drug delivery.

Previously, CQDs were synthesized by laser ablation of carbon (PLQY=10%), polymerization of citric acid and ethylenediamine (PLQY=80%), arc discharge, biomass, chemical oxidation, ultrasonication, solvothermal, and thermal processes. Generally, the shape of the CQDs is spherical, often synthesized using small molecules, assembling polymers/biomass, polymerization, crosslinking, and carbonization through “bottom-up” approaches (i.e., combustion, thermal treatment, and the like). Among the CQDs synthesis methods, biomass-originated CQDs are promising because of their environmentally-friendliness, cost-effectiveness, rich availability of raw materials, and natural doping of heteroatoms (i.e., B, N, S, P, and the like).

Although efforts have been taken to convert biomass into CQDs, the need to address biomass-derived CQD's shortcomings—low PLQY and/or narrow Stokes shift—has not been met. Accordingly, an object of the present disclosure is to describe a method of making CQDs from melon biomass that can overcome the limitations of the art, and corresponding CDQs made by the method.

### SUMMARY

In an exemplary embodiment of the present disclosure, a method for synthesizing carbon quantum dots. The method includes reacting a mixture of a fruit waste material and deionized water hydrothermally in an autoclave at a reaction temperature in a range of 150° C. to 250° C. to form a carbon quantum dot containing suspension. The method includes centrifuging the carbon quantum dot containing suspension to separate the carbon quantum dots from a hydrochar. The method includes filtering the carbon quantum dot containing suspension to obtain the carbon quantum dots. The carbon quantum dots have a size ranging from 2 to 10 nanometers (nm), and a Stokes shift of at least 150 nm at an excitation wavelength of 360 nm or lower.

In some embodiments, the method further includes drying the fruit waste material before reacting the mixture of fruit waste material and deionized water.

In some embodiments, the method includes reacting the mixture of the fruit waste material for at least 24 hours.

In some embodiments, the method includes filtering the carbon quantum dot-containing suspension including passing the carbon quantum dot-containing suspension through a filter with a pore size of 0.22 micrometers (μm).

In some embodiments, the fruit waste material is a canary melon.

In some embodiments, the fruit waste material is the skin of a canary melon.

In some embodiments, the method includes reacting the fruit waste material at the reaction temperature in a range of 160° C. to 200° C. and forms carbon quantum dots having a crystallite size from 0.5 to 1.5 nm.

In some embodiments, the method includes reacting the fruit waste material at the reaction temperature in a range of 160° C. to 200° C. and forms carbon quantum dots having an average height of 0.2 to 0.4 nm.

In some embodiments, the method includes reacting the fruit waste material at the reaction temperature in a range of 160° C. to 200° C. and forms carbon quantum dots having a diameter ranging from 4 to 6 nm.

In some embodiments, the method includes reacting the fruit waste material at the reaction temperature in a range of 160° C. to 200° C. and forming carbon quantum dots having carbon in an amount of 50 to 65 at. %, oxygen in an amount of 24 to 38 at. %, sodium in an amount of 0.5 to 3 at. %, magnesium in an amount of 0.5 to 3 at. %, chloride in an amount of 0.5 to 5 at. %, and potassium in an amount of 2 to 10 at. % based on the total atom count of the carbon quantum dots.

In some embodiments, the method includes reacting the fruit waste material at the reaction temperature in a range of 160° C. to 200° C. and forms carbon quantum dots having a UV-visible absorption spectra signal in a 250 to 400 nm wavelength range.

In some embodiments, the UV-visible absorption spectra signal includes a first peak from 295 to 302 nm, a second peak from 303 to 310 nm, a third peak from 318 to 320 nm, and a fourth peak from 335 to 340 nm.

In some embodiments, the UV-visible absorption spectra signal has a total peak area of 30 to 65 atomic units (au).

In some embodiments, the method includes reacting the fruit waste material at the reaction temperature in a range of 160° C. to 200° C. and forms carbon quantum dots having a UV-visible emission spectra signal in a 450 to 800 nm wavelength range at an excitation wavelength of 300 to 480 nm.

In some embodiments, the UV-visible emission spectra signal comprises a first peak from 470 to 510 nm, a second peak from 500 to 550 nm, a third peak from 550 to 600 nm, a fourth peak from 600 to 650 nm, and a fifth peak from 650 to 670 nm.

In some embodiments, the UV-visible emission spectra signal has a peak area from 0.8×10⁷ to 7.0×10⁷ at an excitation wavelength of 380 nm.

In some embodiments, the method includes reacting the fruit waste material at a reaction temperature of 180° C. to form carbon quantum dots having a photoluminescence quantum yield that is 3- to 4-fold greater than the photoluminescence quantum yield of the carbon quantum dots formed at the reaction temperature of 160° C.

In some embodiments, the method includes reacting the fruit waste material at a reaction temperature of 200° C. to form carbon quantum dots having a photoluminescence quantum yield that is 7- to 8-fold greater than the photoluminescence quantum yield of the carbon quantum dots formed at a reaction temperature of 160° C.

In some embodiments, the method includes reacting the fruit waste material at the reaction temperature in a range of 160° C. to 200° C. and forms carbon quantum dots having a Stokes shift from 220 to 250 nm at an excitation wavelength of 300 nm.

The foregoing general description of the illustrative present disclosure and the following detailed description thereof are merely exemplary aspects of the teachings of this disclosure and are not restrictive. These and other aspects of non-limiting embodiments of the present disclosure will become apparent to those skilled in the art upon review of the following description of specific non-limiting embodiments of the disclosure in conjunction with the accompanying drawings.

### BRIEF DESCRIPTION OF THE DRAWINGS

A more complete appreciation of the present disclosure (including alternatives and/or variations thereof) and many of the attendant advantages thereof will be readily obtained as the same becomes better understood by reference to the following detailed description of the embodiment when considered along with the accompanying drawings, wherein:

FIG. 1 is a flowchart depicting a method of synthesizing carbon quantum dots (CQDs), according to certain embodiments;

FIG. 2A shows X-ray diffraction (XRD) patterns of the CQDs synthesized at various temperatures, according to certain embodiments;

FIG. 2B shows Fourier-transform infrared (FTIR) spectra of the CQDs synthesized at various temperatures, according to certain embodiments;

FIG. 3A shows an atomic force microscopy (AFM) image of the CQDs synthesized at 160° C., according to certain embodiments;

FIG. 3B shows an AFM image of the CQDs synthesized at 180° C., according to certain embodiments;

FIG. 3C shows an AFM image of the CQDs synthesized at 200° C., according to certain embodiments;

FIG. 4A shows a transmission electron microscopy (TEM) image of the CQDs synthesized at 160° C., according to certain embodiments;

FIG. 4B shows a TEM image of the CQDs synthesized at 180° C., according to certain embodiments;

FIG. 4C shows a TEM image of the CQDs synthesized at 200° C., according to certain embodiments;

FIG. 5A shows a scanning electron microscope (SEM) image of the CQDs synthesized at 180° C., according to certain embodiments;

FIG. 5B shows energy dispersive X-ray spectroscopy (EDS) elemental mapping of the CQDs, depicting carbon (C), oxygen (O), sodium (Na), magnesium (Mg), potassium (K), and chlorine (Cl), synthesized at 180° C., according to certain embodiments;

FIG. 5C shows EDS elemental mapping of the CQDs, depicting C, synthesized at 180° C., according to certain embodiments;

FIG. 5D shows EDS elemental mapping of the CQDs, depicting 0, synthesized at 180° C., according to certain embodiments;

FIG. 5E shows EDS elemental mapping of the CQDs, depicting Na, synthesized at 180° C., according to certain embodiments;

FIG. 5F shows EDS elemental mapping of the CQDs, depicting Mg, synthesized at 180° C., according to certain embodiments;

FIG. 5G shows EDS elemental mapping of the CQDs, depicting K, synthesized at 180° C., according to certain embodiments;

FIG. 5H shows EDS elemental mapping of the CQDs, depicting Cl, synthesized at 180° C., according to certain embodiments;

FIG. 6A shows a deconvoluted absorption spectrum of the CQDs synthesized at 160° C., according to certain embodiments;

FIG. 6B shows a deconvoluted absorption spectrum of the CQDs synthesized at 180° C., according to certain embodiments;

FIG. 6C shows a deconvoluted absorption spectrum of the CQDs synthesized at 200° C., according to certain embodiments;

FIG. 6D shows the elemental composition of the CQDs synthesized at different temperatures, according to certain embodiments;

FIG. 7A shows an absorption spectrum of the CQDs synthesized at 160° C., according to certain embodiments;

FIG. 7B shows an absorption spectrum of the CQDs synthesized at 180° C., according to certain embodiments;

FIG. 7C shows an absorption spectrum of the CQDs synthesized at 200° C., according to certain embodiments;

FIG. 7D shows a deconvoluted absorption peak position of the CQDs synthesized at different temperatures, according to certain embodiments;

FIG. 7E shows the adsorption area of the CQDs synthesized at different temperatures, according to certain embodiments;

FIG. 8 is an optical image of the CQDs in white light and in ultraviolet (UV) light of the CQDs synthesized at different temperatures, according to certain embodiments;

FIG. 9A shows photoluminescence emission spectra of the CQDs synthesized at 160° C., for different excitation wavelengths in the range of 300-480 nm, according to certain embodiments;

FIG. 9B shows photoluminescence emission spectra of the CQDs synthesized at 180° C., for different excitation wavelengths in the range of 300-480 nm, according to certain embodiments;

FIG. 9C shows photoluminescence emission spectra of the CQDs synthesized at 200° C., for different excitation wavelengths in the range of 300-480 nm, according to certain embodiments;

FIG. 10A shows a comparison of the photoluminescence peak position of the CQDs synthesized at different temperatures, for the excitation wavelength of 440, 460, and 480 nm, according to certain embodiments;

FIG. 10B shows a comparison of the photoluminescence peak intensity of the CQDs synthesized at different temperatures, for the excitation wavelength of 440, 460, and 480 nm, according to certain embodiments;

FIG. 11A shows a deconvoluted photoluminescence emission spectrum of the CQDs synthesized at 160° C., according to certain embodiments;

FIG. 11B shows a deconvoluted photoluminescence emission spectrum of the CQDs synthesized at 180° C., according to certain embodiments;

FIG. 11C shows a deconvoluted photoluminescence emission spectrum of the CQDs synthesized at 200° C., according to certain embodiments;

FIG. 11D shows a comparison of the photoluminescence peak area of three dominating peaks (peak-1, peak-2, and peak-3) of the CQDs, according to certain embodiments;

FIG. 11E shows a comparison of positions of emission peaks (peak-1, peak-2, peak-3, peak-4, and peak-5) of the CQDs, according to certain embodiments;

FIG. 12A shows a three-dimensional (3D) map of the photoluminescence peak position of the CQDs synthesized at various temperatures, according to certain embodiments;

FIG. 12B shows a 3D map of the Stokes shift of the CQDs synthesized at various temperatures, according to certain embodiments; and

FIG. 12C shows a 3D map of the photoluminescence peak intensity of the CQDs synthesized at various temperatures, according to certain embodiments.

### DETAILED DESCRIPTION

In the following description, it is understood that other embodiments may be utilized, and structural and operational changes may be made without departure from the scope of the present embodiments disclosed herein.

Reference will now be made in detail to specific embodiments or features, examples of which are illustrates in the accompanying drawings. Whenever possible, corresponding or similar reference numbers will be used throughout the drawings to refer to the same or corresponding parts. Moreover, reference to various elements described herein are made collectively or individually when there may be more than one element of the same type. However, such references are merely exemplary in nature. It may be noted that any reference to elements in the singular may also be constructed to relate to the plural and vice-versa without limiting the scope of the disclosure to the exact number or type of such elements unless set forth explicitly in the appended claims. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

As used herein, the term “Stokes shift” refers to the difference (in energy, wavenumber, or frequency units) between positions of the band maxima of the absorption spectra and the band maxima of the emission spectra (i.e., from fluorescence, ultraviolet-visible, and Raman spectroscopy) of the same electronic transition.

As used herein, the term “photoluminescence” (PL) occurs when absorption of light energy, or photons (electromagnetic radiation), stimulates the emission of a photon. Photoluminescence is light emission from any form of matter after the absorption of photons. It is a form of luminescence (light emission) and is initiated by photoexcitation (i.e., photons that excite electrons to a higher energy level in an atom). Following excitation, various relaxation processes occur in which other photons may be re-radiated. Time periods between absorption and emission may vary. Photoluminescence may take on forms such as fluorescence, phosphorescence, and chemiluminescence.

As used herein, the term, “photoluminescence quantum yield (PLQY)” is the number of photons emitted as a fraction of the number of photons absorbed.

Aspects of the present disclosure are directed to a cost-effective method to synthesize carbon quantum dots (CQDs) using waste biomass. The synthesis is carried out at various temperatures, preferably a range of 150° C. to 250° C., more preferably 160° C., 180° C., and 200° C. The average particle size of the CQDs is preferably from about 3 nm to about 6 nm, and preferably 5.2, 4.8, and/or 4.3 nm for the synthesis temperature of 160, 180, and 200° C., respectively. The PL emission peak position is blueshifted with the rise in the synthesis temperature. The optical properties of the synthesized CQDs were studied, and the results indicate that the PLQY increased by 3.5- and 7.2-fold for the rise in the temperature from 160 to 180 and from 160 to 200° C., respectively. The Stokes shift is reduced with a rise in the synthesis temperature. The results indicate that the applicability of CQDs synthesized by the method of present disclosure may be enriched via the selection of the synthesis parameters.

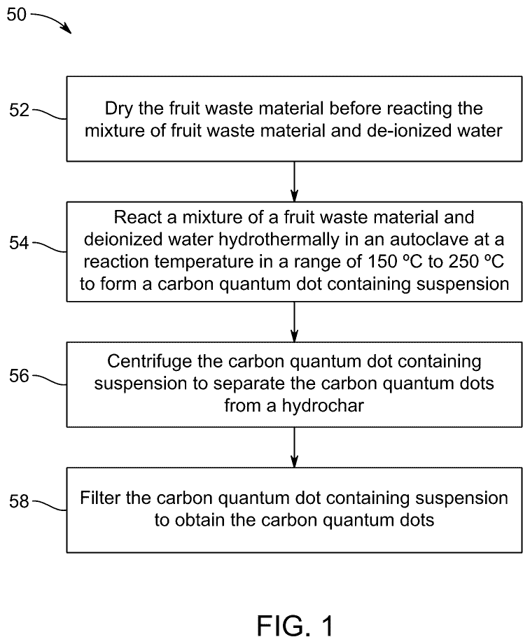

FIG. 1 illustrates a flow chart of a method 50 of synthesizing carbon quantum dots (CQDs). The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes drying the fruit waste material before reacting the mixture of fruit waste material and de-ionized water. The fruit waste material is a rich source of carbon material and has polyphenols, oils, and carotenoids, which can be used as a precursor for preparing the CQDs. As used herein, the “fruit waste material” refers to waste material deriving from fruits that are biodegradable and includes the peel, skin, rind, pulp, flesh, seeds, stem, roots, vines, leaves and the like. In an embodiment, the waste material is obtained from melon. The melon maybe watermelon, cantaloupe, honeydew, winter melon, casaba melon, Persian melon, Gallia melon, snap melon, canary melon, bitter melon, Crenshaw melon, Christmas melon, ananas melon, crane melon, ambrosia melon, honey globe melon, autumn sweet, Armenian cucumber, gac melon, cucamelon, ivory gaya, the like, and/or combinations thereof. In an embodiment, the fruit waste material is obtained from canary melon (Cucumis melo (Inodorus group)). Although various parts, such as leaves, seeds, roots, fruits, skin, pulp, flesh, and/or combinations thereof, of waste material deriving from fruits may be used to prepare the fruit waste material, in a preferred embodiment, the skin of the melon is used to prepare the fruit waste material. The skin may be an outer wall surface of the melon, an inner wall surface that connects the flesh to outer wall surface of the melon, and a combination thereof. In an embodiment, the skin of the melon is an outer most surface of the melon. In a preferred embodiment, the fruit waste material is obtained from the canary melon, more particularly, from the skin of the canary melon, e.g., the skin having a thickness from the outside of the melon inwards of 5 mm, preferably 4 mm, 3 mm or 2 mm.

The skin of the canary melon is rich in water. It is peeled, cut into pieces, and dried under the sun for 6 to 48 hours for the evaporation of water. The dried peels are then ground using a mortar and pestle, a food processor, a mixer, a grinder, and the like to obtain a powder. The powder is dissolved/suspended in an appropriate amount of water for further processing. The water may be tap water, deionized water (DIW), distilled water, double distilled water, and the like. In an embodiment, water is DIW. In an embodiment, the ratio of the DIW to the powder is in a range of 5:1 to 75:1, preferably 6:1 to 50:1, preferably 7:1 to 30:1, preferably 8:1 to 20:1, more preferably 9:1 to 15:1, and yet more preferably about 10:1.

At step 54, the method 50 includes reacting a mixture of a fruit waste material and deionized water hydrothermally in an autoclave at a reaction temperature in a range of 150° C. to 250° C. to form a carbon quantum dot containing suspension. The carbon quantum dot containing suspension may be a homogeneous solution, a heterogenous solution, and the like. In a hydrothermal reaction, an aqueous mixture of precursors (i.e., fruit waste material dissolved or suspended in DIW) is heated in a sealed autoclave above the boiling point of water (150° C. to 250° C., preferably 160 to 200° C.), and consequently, the pressure within the reaction autoclave is increased above atmospheric pressure. The synergistic effect of high temperature and pressure is a one-step process to produce crystalline materials without the need for post-annealing treatments. In an embodiment, the autoclave may be stainless-steel, nickel-clad, and a combination thereof. In an embodiment, the autoclave is a stainless-steel-lined Teflon autoclave.

Parameters that affect the size and morphology of the carbon quantum dots relate to the heating time and heating temperature. In an embodiment, the reaction is carried out for 18 to 30 hours, preferably 20 to 28 hours, more preferably 22 to 26 hours, and yet more preferably about 24 hours. The heating temperature is preferably in a range of 160° C. to 200° C. The heating temperature is preferably 160° C., 180° C., and 200° C. The hydrothermal reaction results in a suspension including hydrochar and CQDs.

In an embodiment, the mixture of the fruit waste material and the deionized water is reacted, hydrothermally, at the reaction temperature in a range of 160° C. to 200° C. to form the CQDs having a crystallite size from 0.5 to 1.5 nm, preferably 0.6-1.4 nm, and more preferably 0.65-1.36 nm. In an embodiment, the mixture of the fruit waste material and the deionized water is reacted, hydrothermally, at the reaction temperature in a range of 160° C. to 200° C. to form the CQDs having a d-spacing value of 3.5 to 4.5 nm, preferably 3.6 to 4.4 nm, preferably 3.7 to 4.3 nm, preferably 3.8 to 4.2, more preferably 3.9 to 4.15 nm, and yet more preferably 3.99 to 4.15 nm. In an embodiment, the mixture of the fruit waste material and the deionized water is reacted, hydrothermally, at the reaction temperature in a range of 160° C. to 200° C. to form the CQDs having an average height of 0.2 to 0.4 nm, preferably 0.21 to 0.39 nm, preferably 0.22 to 0.38 nm, preferably 0.23 to 0.37 nm, 0.24 to 0.36 nm, more preferably 0.25 to 0.35 nm, and yet preferably 0.25 to 0.32 nm. In an embodiment, the mixture of the fruit waste material and the deionized water is reacted, hydrothermally, at the reaction temperature in a range of 160° C. to 200° C. to form the CQDs having a diameter ranging from 1 to 10 nm, preferably 2 to 9 nm, preferably 3 to 8 nm, more preferably 4 to 7, and yet more preferably 4 to 6 nm.

In some embodiments, the fruit waste material and deionized water are reacted hydrothermally for at least 24 hours. In some embodiments, the reaction is carried out at the reaction temperature in a range of 160° C. to 200° C. to form the CQDs having carbon in an amount of 50 to 65 at. %, oxygen in an amount of 24 to 38 at. %, sodium in an amount of 0.5 to 3 at. %, magnesium in an amount of 0.5 to 3 at. %, chloride in an amount of 0.5 to 5 at. %, and potassium in an amount of 2 to 10 at. % based on the total atom count of the carbon quantum dots.

In a preferred embodiment, the CQDs include carbon in an amount of 50 to 65 at. %, preferably 51 to 64 at. %, preferably 52 to 62 at. %, preferably 52 to 60 at. %, preferably 52 to 58 at. %, preferably about 52.73 at. %, preferably about 57.3 at. %, and preferably about 61.9 at. %. In a preferred embodiment, the CQDs include oxygen in an amount of 24 to 38 at. %, preferably 25 to 37 at. %, preferably 25.5 to 36.5 at. %, preferably about 25.6 at. %, preferably about 32.8 at. %, and preferably about 36.3 at. %. In a preferred embodiment, the CQDs include sodium in an amount of 0.5 to 3 at. %, preferably 0.6 to 2.6 at. %, preferably 0.7 to 2.2 at. %, preferably about 0.8 at. %, preferably about 1.2 at. %, and preferably about 2.1 at. %. In a preferred embodiment, the CQDs include magnesium in an amount of 0.5 to 3 at. %, preferably 0.6 to 2.8 at. %, preferably 0.7 to 2.6 at. %, preferably 0.8 to 2.4 at. %, preferably about 0.9 at. %, preferably about 1.3 at. %, and preferably about 2.3 at. %. In a preferred embodiment, the CQDs include chloride in an amount of 0.5 to 5 at. %, preferably 0.6 to 4.7 at. %, preferably about 0.7 at. %, preferably 1.5 at. %, and preferably 4.6 at. %. In a preferred embodiment, the CQDs include potassium in an amount of 2 to 10 at. %, preferably 3 to 9 at. %, preferably about 3.2 at. %, preferably 6.1 at. %, and preferably about 8.6 at. %. In a preferred embodiment, the atomic percent (at. %) of CQDs are based on the total atom count of the CQDs.

In an embodiment, the reaction is carried out at the reaction temperature in a range of 160° C. to 200° C. to form the carbon quantum dots having a UV-visible absorption spectra signal in a 250 to 400 nm, preferably 275 to 375 nm, and more preferably 295 to 345 nm wavelength range. The UV-visible absorption spectra signal includes a combination of signals from four peaks. The UV-visible absorption spectra signal includes a first peak from 295 to 302 nm, a second peak from 303 to 310 nm, a third peak from 318 to 320 nm, and a fourth peak from 335 to 340 nm. The UV-visible absorption spectra signal has a total peak area of 30 to 65 au.

In an embodiment, the reaction is carried out at the reaction temperature in a range of 160° C. to 200° C. to form the carbon quantum dots having a UV-visible emission spectra signal in a 450 to 800 nm, and preferably 470 to 700 nm wavelength range at an excitation wavelength of 300 to 480 nm. The UV-visible emission spectra signal includes a combination of signals from five peaks. The UV-visible emission spectra signal includes a first peak from 470 to 510 nm, a second peak from 500 to 550 nm, a third peak from 550 to 600 nm, a fourth peak from 600 to 650 nm, and a fifth peak from 650 to 670 nm. The UV-visible emission spectra signal has an overall peak area from 0.8×10⁷ to 7.0×10⁷, preferably 0.85×10⁷ to 6.5×10⁷ at an excitation wavelength of 380 nm.

In an embodiment, the reaction is carried out at a reaction temperature of 180° C. to form the CQDs having a PLQY that is 3- to 4-fold greater, preferably about 3.5-fold greater, than the PLQY of the CQDs formed at the reaction temperature of 160° C. In an embodiment, the reaction is carried out at a reaction temperature of 200° C. to form CQDs having a PLQY that is 7- to 8-fold greater, preferably about 7.2-fold greater, than the PLQY of the carbon quantum dots formed at a reaction temperature of 160° C. The results suggest that the temperature selection influences the PLQY of the CQDs.

As used herein, a “-fold” or “fold change” is a measure describing how much a quantity changes between a first sample and a second sample. A fold change is the ratio between two quantities. In an example, if a first signal is increased 3-fold a second signal, the first signal is 3 times more than the second signal. In an example of the present disclosure, CQDs formed at 180° C. having a PLQY that is about 3.5-fold greater than the PLQY of CQDs formed at 160° C. means the value of the PLQY from the CQDs formed at 180° C. is about 3.5 times more than the value of the PLQY from the CQDs formed at 160° C.

In some embodiments, the reaction is carried out at the reaction temperature in a range of 160° C. to 200° C. to form the carbon quantum dots having a Stokes shift from 220 to 250 nm at an excitation wavelength of 300 nm. In some embodiments, the reaction is carried out at the reaction temperature in a range of 160° C. to 200° C. to form the carbon quantum dots having a Stokes shift from 195 to 230 nm at an excitation wavelength of 320 nm. In some embodiments, the reaction is carried out at the reaction temperature in a range of 160° C. to 200° C. to form the carbon quantum dots having a Stokes shift from 175 to 210 nm at an excitation wavelength of 340 nm. In some embodiments, the reaction is carried out at the reaction temperature in a range of 160° C. to 200° C. to form the carbon quantum dots having a Stokes shift from 150 to 190 nm at an excitation wavelength of 360 nm. In some embodiments, the reaction is carried out at the reaction temperature in a range of 160° C. to 200° C. to form the carbon quantum dots having a Stokes shift from 130 to 165 nm at an excitation wavelength of 380 nm. In some embodiments, the reaction is carried out at the reaction temperature in a range of 160° C. to 200° C. to form the carbon quantum dots having a Stokes shift from 105 to 140 nm at an excitation wavelength of 400 nm. In some embodiments, the reaction is carried out at the reaction temperature in a range of 160° C. to 200° C. to form the carbon quantum dots having a Stokes shift from 90 to 110 nm at an excitation wavelength of 420 nm. In some embodiments, the reaction is carried out at the reaction temperature in a range of 160° C. to 200° C. to form the carbon quantum dots having a Stokes shift from 70 to 90 nm at an excitation wavelength of 440 nm. In some embodiments, the reaction is carried out at the reaction temperature in a range of 160° C. to 200° C. to form the carbon quantum dots having a Stokes shift from 55 to 75 nm at an excitation wavelength of 460 nm. In some embodiments, the reaction is carried out at the reaction temperature in a range of 160° C. to 200° C. to form the carbon quantum dots having a Stokes shift from 50 to 65 nm at an excitation wavelength of 480 nm.

In some embodiments, the reaction is carried out at the reaction temperature in a range of 160° C. to 200° C. to form the carbon quantum dots having a photoluminescence intensity from 3×10³ to 5×10⁷ a.u. at an excitation wavelength of 300 to 480 nm. In some embodiments, the reaction is carried out at the reaction temperature in a range of 160° C. to 200° C. to form the carbon quantum dots having a photoluminescence intensity from 1×10⁷ to 5×10⁷ a.u. at an excitation wavelength of 480 nm.

At step 56, the method 50 includes centrifuging the carbon quantum dot containing suspension to separate the carbon quantum dots from a hydrochar. The centrifugation is carried out using a centrifuge, and these methods are obvious to a person skilled in the art.

At step 58, the method 50 includes filtering the carbon quantum dot containing suspension to obtain the carbon quantum dots. In some embodiments, the method includes filtering the carbon quantum dot-containing suspension includes passing the carbon quantum dot-containing suspension through a filter with a pore size of 0.22 μm. The CQDs prepared by the method of the present disclosure have a size ranging from 2 to 10 nm, preferably 3 to 9 nm, preferably 4 to 8 nm, preferably 4 to 7 nm, preferably 4 to 6 nm, preferably 4.3 to 5.2 nm; and a Stokes shift of at least 150 nm at an excitation wavelength of 360 nm or lower.

### Examples

The following examples demonstrate a method of synthesizing carbon quantum dots (CQDs) as described herein. The examples are provided solely for illustration and are not to be construed as limitations of the present disclosure, as many variations thereof are possible without departing from the spirit and scope of the present disclosure.

### Synthesis of the CQDs

First, the fruit waste material (canary melon skin) was dried in the sun. A powder was formed via a mixture grinder. The powder was washed thoroughly in deionized water (DIW). Then, 7 g of the powder was dispersed in 70 mL of DIW. The dispersed mixture was transferred to a stainless steel-lined Teflon autoclave (100 mL). A hydrothermal reaction was carried out for 24 hours at various reaction temperatures (160, 180, and 200° C.) to form the CQDs. After natural cooling, the CQDs-containing suspension was separated from the hydrochar via a centrifugation process. The suspension was further filtered using a syringe filter of the pore size of 0.22 m. The CQDs synthesized at 160, 180, and 200° C. are referred to as CQD-160, CQD-180, and CQD-200, respectively.

### Characterization

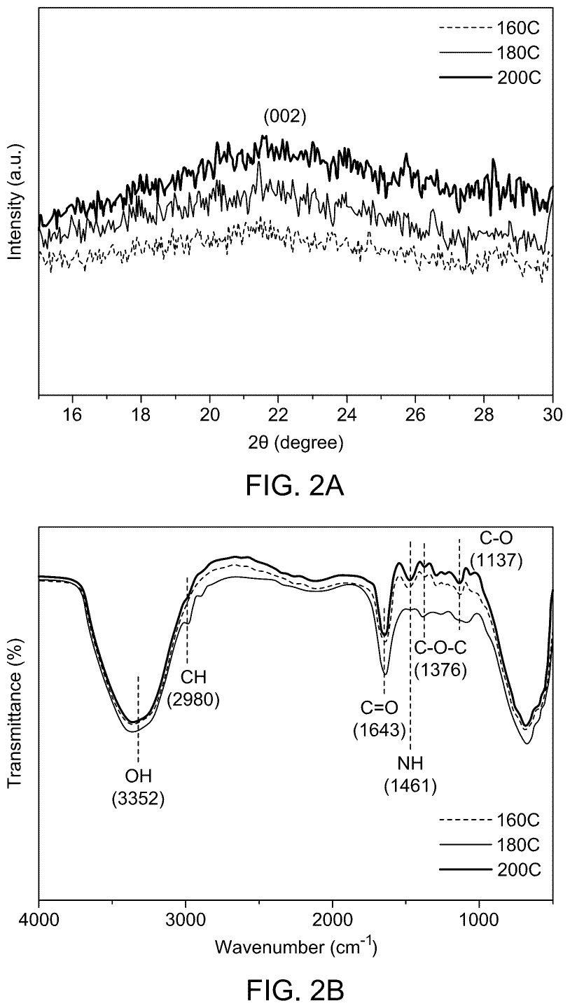

The X-ray diffraction (XRD; Rigaku Miniflex-II system, manufactured by Rigaku, Japan) patterns of the CQDs were recorded using a Cu/Kα radiation (λ=1.5406 Å). Fourier-transform infrared (FTIR; Smart iTR NICOLET iS10, manufactured by Thermo Fisher Scientific, Waltham, Massachusetts, United States) transmission spectra were investigated at room temperature over the wavenumber range of 400-4000 cm⁻¹. The field-emission scanning electron microscopy (FESEM) images of the CQDs were obtained using a (JEOL SEM; JSM6610LV, Japan). The absorption spectra were obtained using ultraviolet-visible (UV-Vis) spectroscopy (JASCO UV-Vis-NIR spectrometer; Model: V-670, Japan). The high-resolution morphology and size of the CQDs were obtained using transmission electron microscopy (TEM) (JEOL; Model: JEM2100F, Japan). PL spectra were obtained using photoluminescence (PL) spectroscopy (FluoroLog-Modular Spectrofluorometer, Horiba Scientific, Japan). The height of the CQDs was determined using an atomic force microscope (AFM) (Agilent 5500, manufactured by Agilent, California, United States). The structural properties of the CQDs were obtained using XRD analysis (FIG. 2A). There is one XRD peak observed in each of the samples related to the diffraction (002) plane of graphitic structure [Li, P. et. al., Formation and fluorescent mechanism of red emissive carbon dots from o-phenylenediamine and catechol system. Light: Science & Applications, 2022. 11(1): p. 298]. The peak positioned at 20 is 21.37, 21.46, and 22.21° for CQD-160, CQD-180, and CQD-200, respectively. The obtained full width at half maxima is 5.96, 11.85, and 12.34°, which were used to calculate the crystallite size and d-spacing. The obtained crystallite sizes are 1.36, 0.68, and 0.65 for the synthesis temperatures of 160, 180, and 200° C., respectively. The corresponding d-spacing values are 4.15, 4.13, and 3.99 nm, respectively. These results reveal that the crystallite size and d-spacing of the CQDs are reduced with an increase in the synthesis temperature.

FTIR transmission spectra were obtained to carry out the bonding analysis of the synthesized CQDs. FIG. 2B shows the FTIR spectra of the CQDs. A broad absorption band centered at 3352 cm⁻¹ is related to the stretching vibration of O—H. Another small peak is seen at 2980 cm⁻¹, which is associated with the stretching vibrations of C—H. The absorption peaks positioned at 1643, 1461, 1376, and 1137 cm⁻¹ are attributed to C═O, N—H, C—O—C, and C—O, respectively. The broad absorption peak centered at ˜700 cm⁻¹ is due to the presence of C—H bonding of the benzene ring.

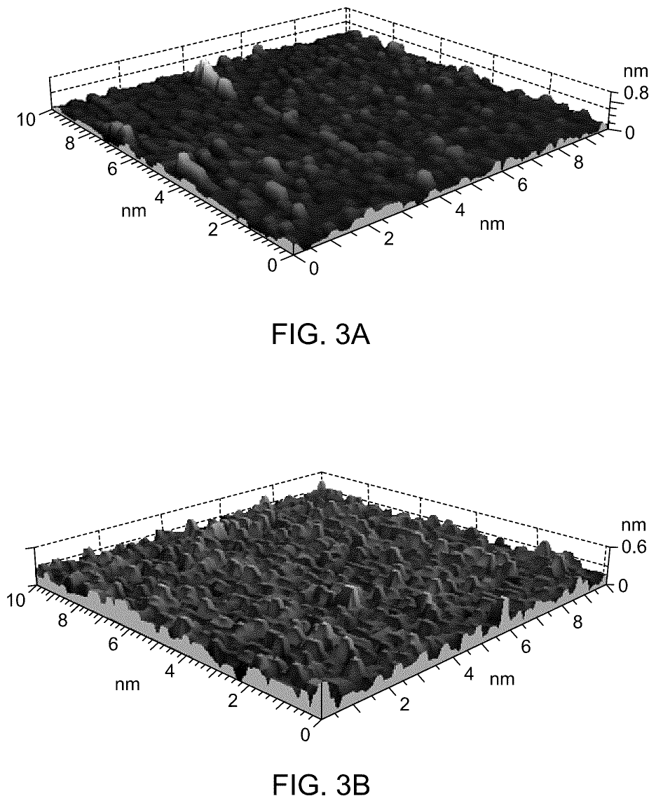

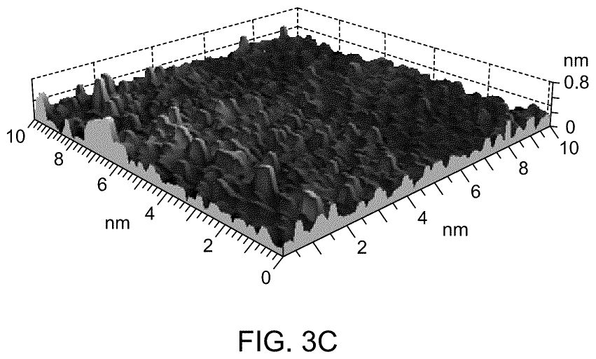

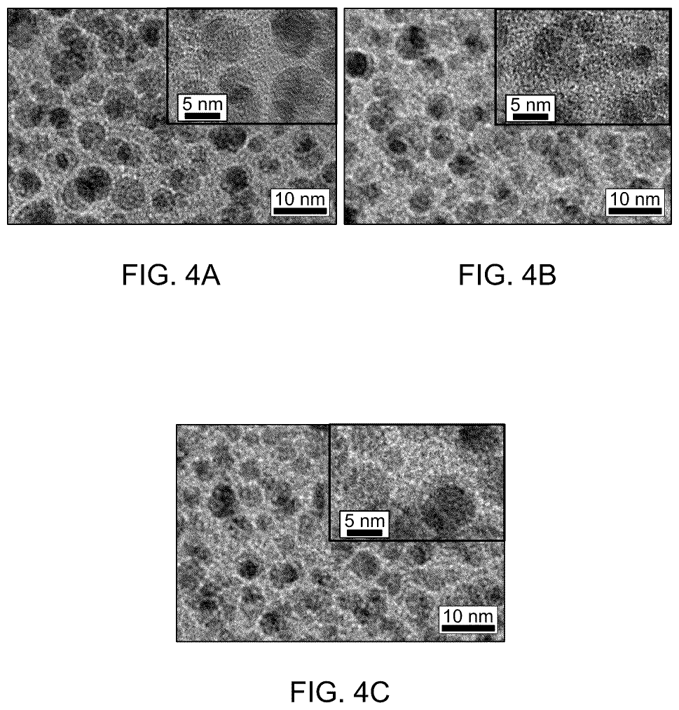

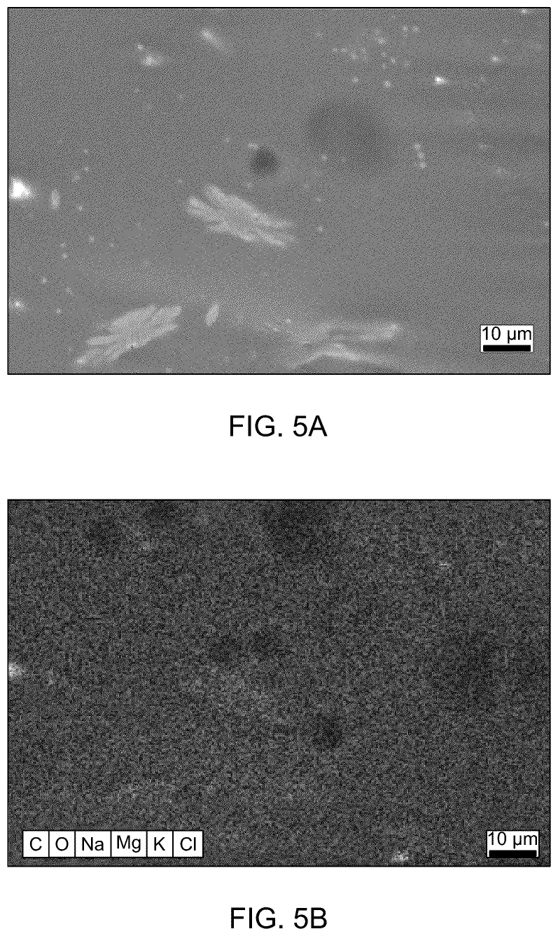

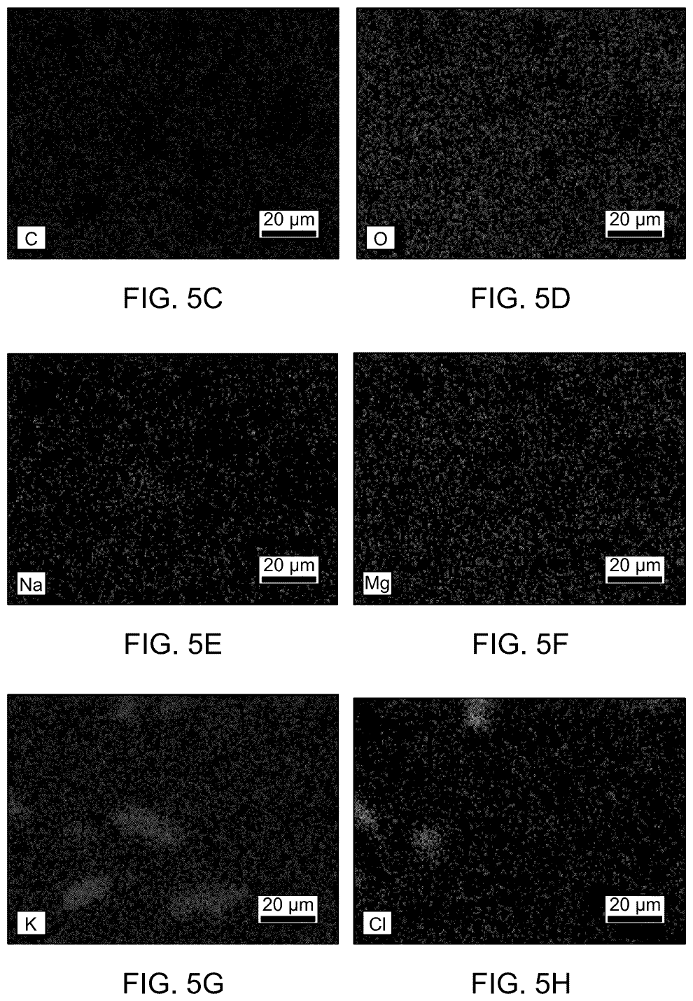

The morphology and size of the CQDs are examined using AFM and TEM. FIGS. 3A-3C display the AFM images of the CQDs synthesized at 160, 180, and 200° C., respectively. The sizes of the CQDs are similar. The average height obtained for the CQDs are 0.25, 0.28, and 0.32 nm synthesized at 160, 180, and 200° C., respectively. The TEM images of the CQDs synthesized at 160, 180, and 200° C. are shown in FIGS. 4A-4C, respectively. FIG. 4 confirms the uniform CQDs growth. The average size of the CQDs is 5.2, 4.8, and 4.3 nm for the synthesis temperature of 160, 180, and 200° C., respectively. The SEM images along with EDS elemental mapping are obtained to examine the elemental distribution. The SEM image of CQD-180 is illustrated in FIG. 5A.

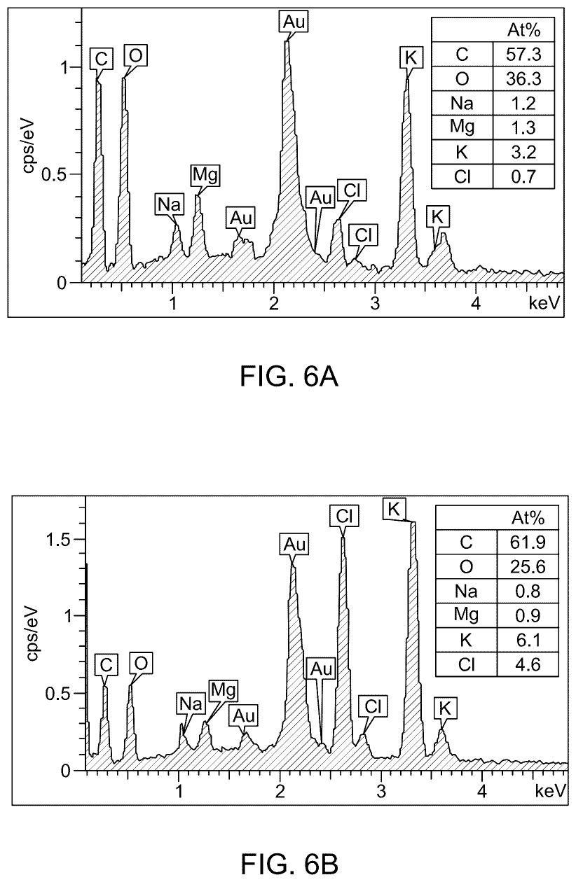

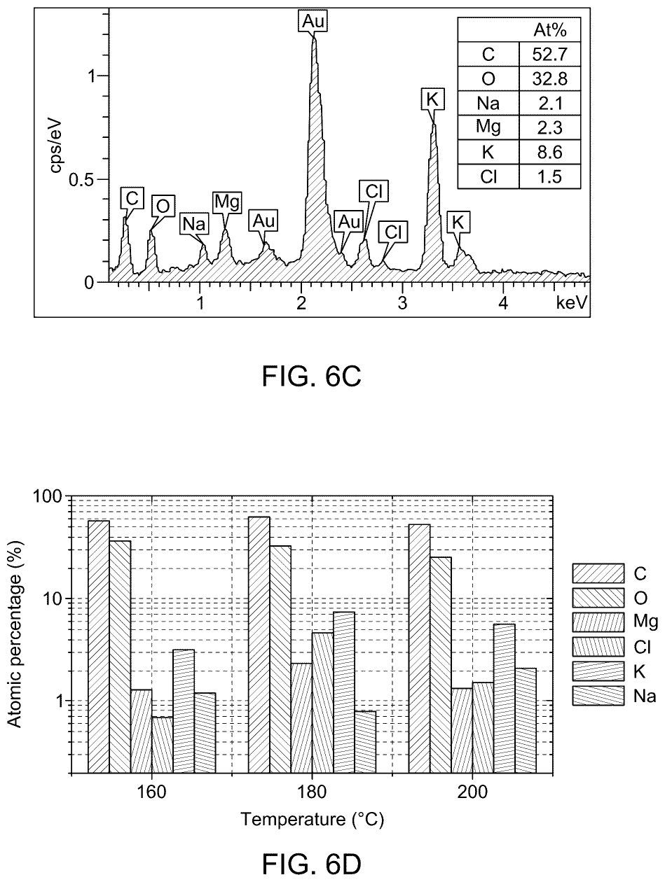

The elemental EDS mapping revealed that the synthesized CQDs show the presence of carbon (C), oxygen (O), sodium (Na), magnesium (Mg), potassium (K), and chloride (Cl) (FIG. 5B). The synthesized CQDs are carbon-rich (FIG. 5C), in which the second dominant element is oxygen (FIG. 5D). The other elements present are Na, Mg, K, and Cl (FIG. 5E-FIG. 5H, respectively). Furthermore, the EDS spectra of the CQDs synthesized at 160° C., 180° C., and 200° C. are shown in FIGS. 6A-6C, respectively. The atomic percentage of each element is shown in FIG. 6D. The obtained carbon content is 57.30, 61.9, and 52.7 at. % in CQD-160, CQD-180, and CQD-200, respectively. The corresponding atomic percentage of oxygen is 36.30, 25.60, and 32.80% in CQD-160, CQD-180, and CQD-200, respectively. The 3.2 at. % of potassium is observed in CQD-160, which is gradually increased to 6.10 and 8.60 at. % for the synthesis temperature of 180 and 200° C., respectively (FIG. 6D).

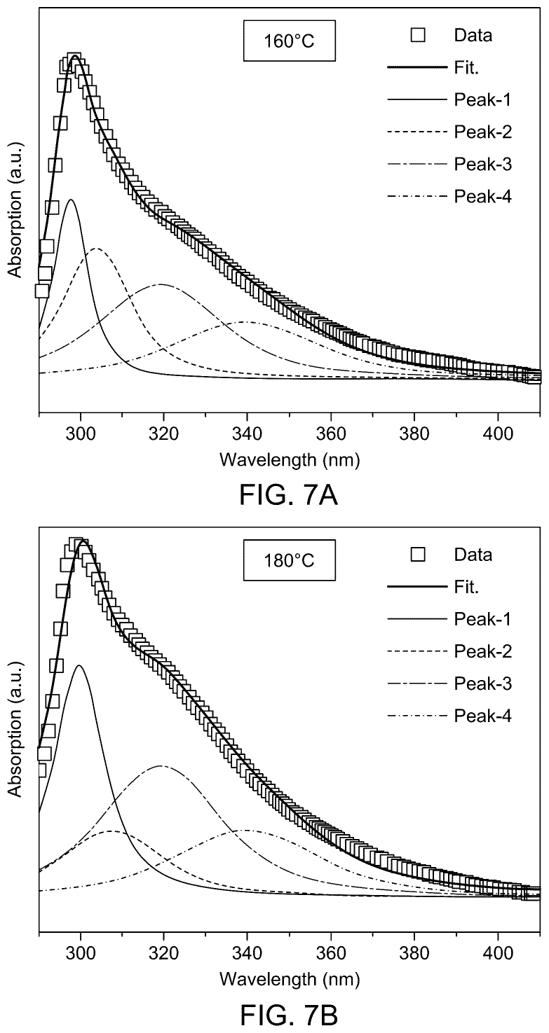

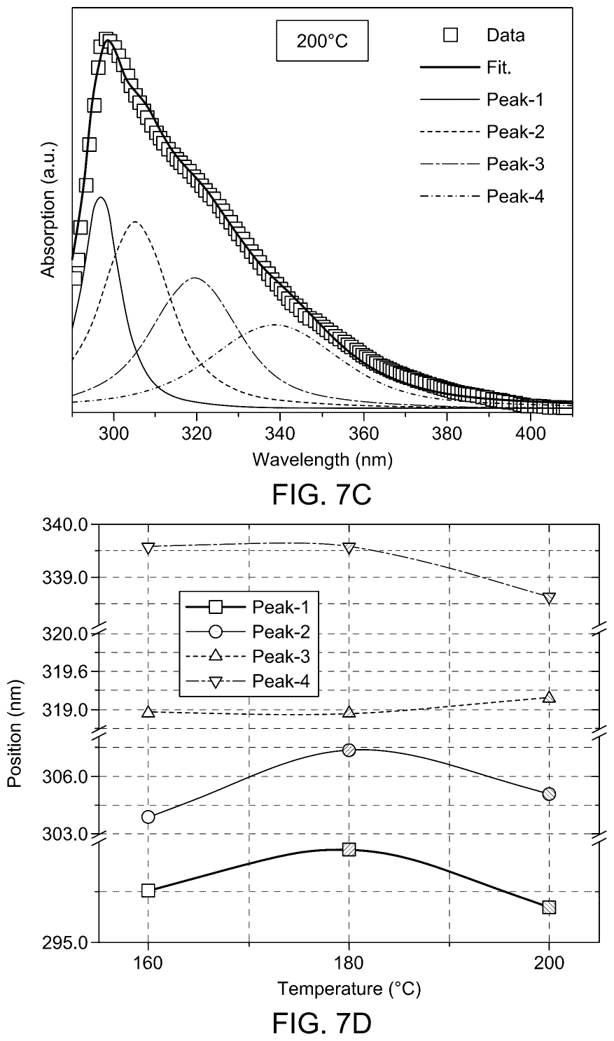

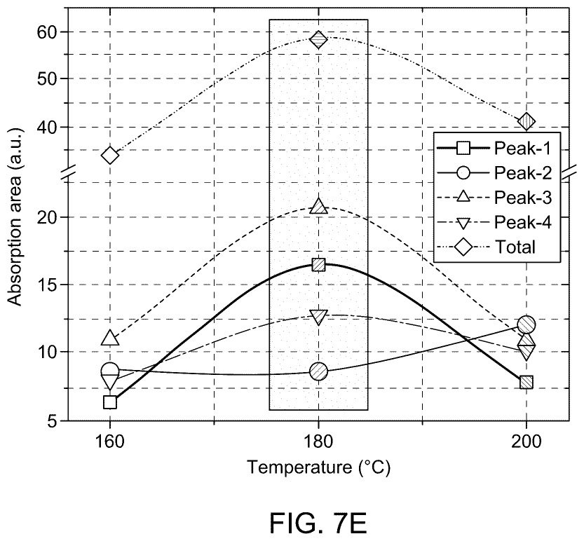

FIGS. 7A-7C show UV-vis absorption spectra of the CQDs dispersed in DIW, synthesized at 160, 180, and 200° C. The samples have a broad absorption in the 250 to 400 nm wavelength range. The absorption peaks were deconvoluted into four peaks. The absorption peaks arise due to pi-to-pi star (π→π*) transitions. The deep UV transition for the λ value below 250 nm is related to a π→π* transition of C═C. The absorption at λ>250 nm is ascribed due to an π→π* transition of C═O bonding [Khan, F. and J. H. Kim, N-Functionalized Graphene Quantum Dots with Ultrahigh Quantum Yield and Large Stokes Shift: Efficient Downconverters for CIGS Solar Cells. ACS Photonic, 2018. 5(11): p: 4637-4643].

The deconvoluted peaks obtained for CQD-160 are positioned at 295.5, 303.9, 319.2, and 339.6 nm, which correspond to 4.17, 4.08, 3.88, and 3.65 eV, respectively (FIG. 7A). The first two peaks are redshifted on increasing the synthesis temperature to 180° C., while the position of other peaks remained constant (FIG. 7B). A redshift is an increase in a wavelength, and a corresponding decrease in a frequency and photon energy, of electromagnetic radiation. Further rise in the synthesis temperature to 200° C. corresponds to peak-1, peak-2, and peak-4 being blueshifted; however, peak-3 is slightly redshifted (FIG. 7C and FIG. 7E). A blueshift is also known as a negative redshift, or a decrease in wavelength and an increase in frequency. A comparison of the absorption spectra is made (FIG. 7D). The highest absorption was obtained for CQD-180 (FIG. 7E). For the quantitative analysis, the absorption peak area was calculated. It was found that the integrated area of peak-1, peak-3, and peak-4 increased for CQD-180, while the area of peak-2 remained unchanged. The area of peak-2 slightly increased for the synthesis temperature of 200° C. The area of peak-1, peak-3, and peak-4 of CQD-200 is nearly similar to that of CQD-160. The obtained total area is 34, 59, and 41 (a.u.) for CQD-160, CQD-180, and CQD-200, respectively.

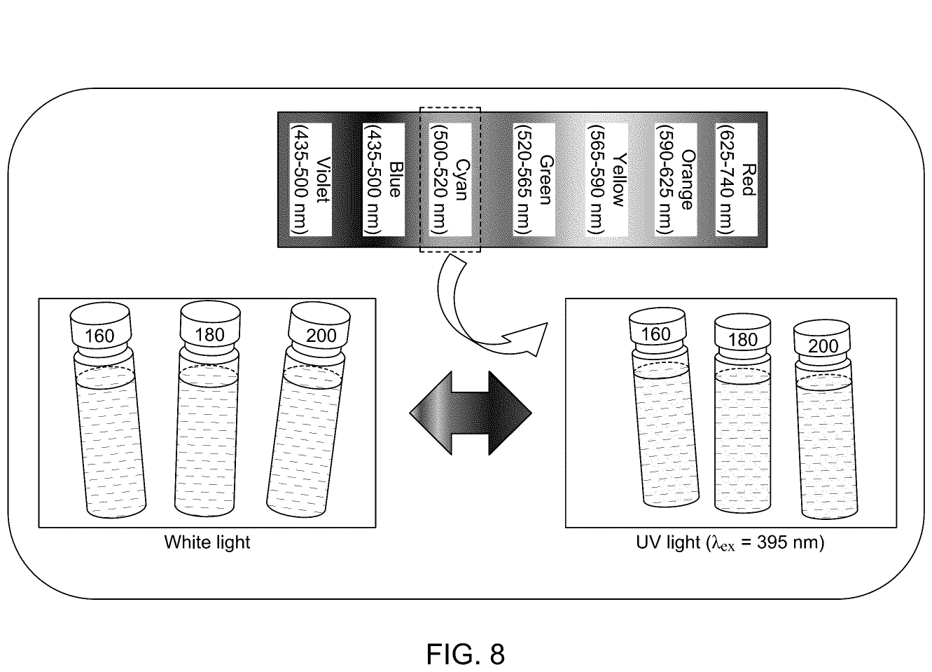

The optical image of the CQDs dissolved in DIW in white light and in UV light (right, λₑₓ=395 nm) is shown in FIG. 8. It was observed that the color of the CQDs in white light was light brown. After UV illumination (λₑₓ=395 nm), the CQDs are a cyan-green color. The cyan-green color belongs to the wavelength range of 500 to 540 nm.

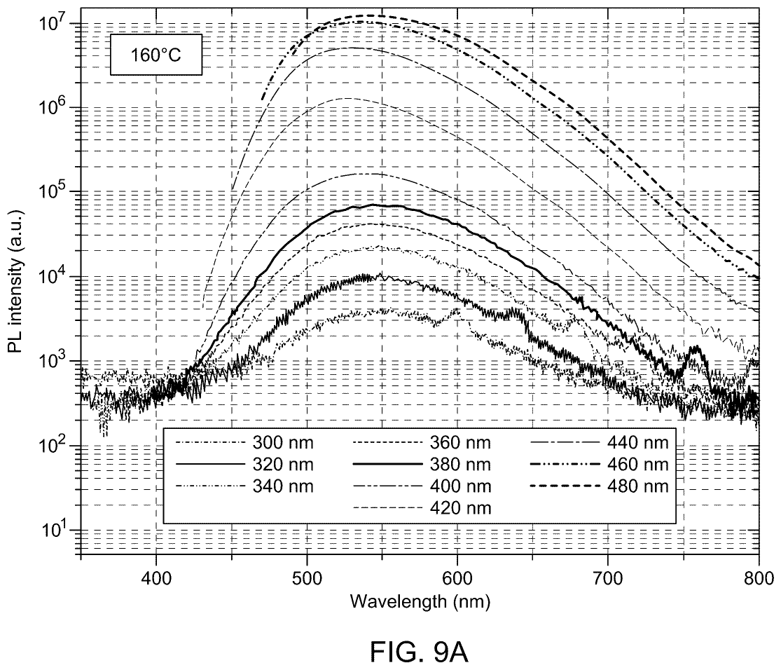

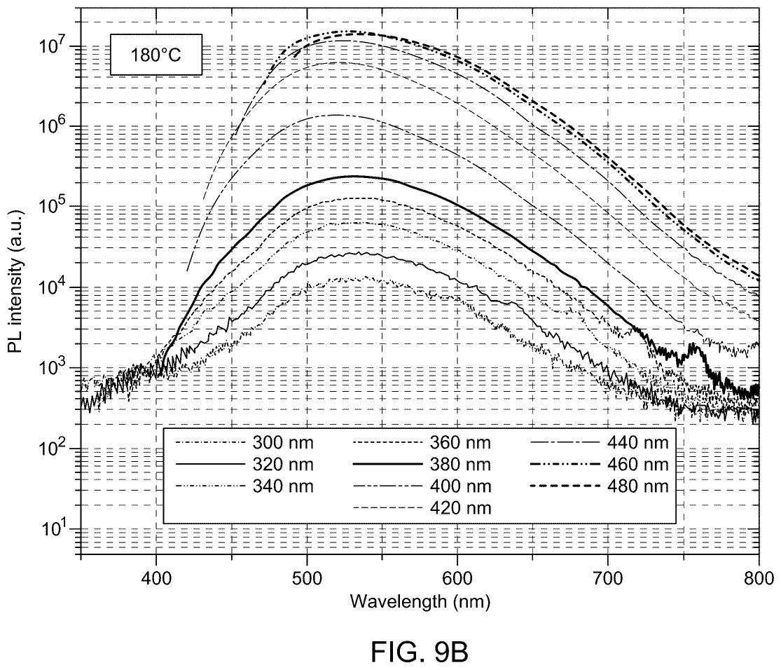

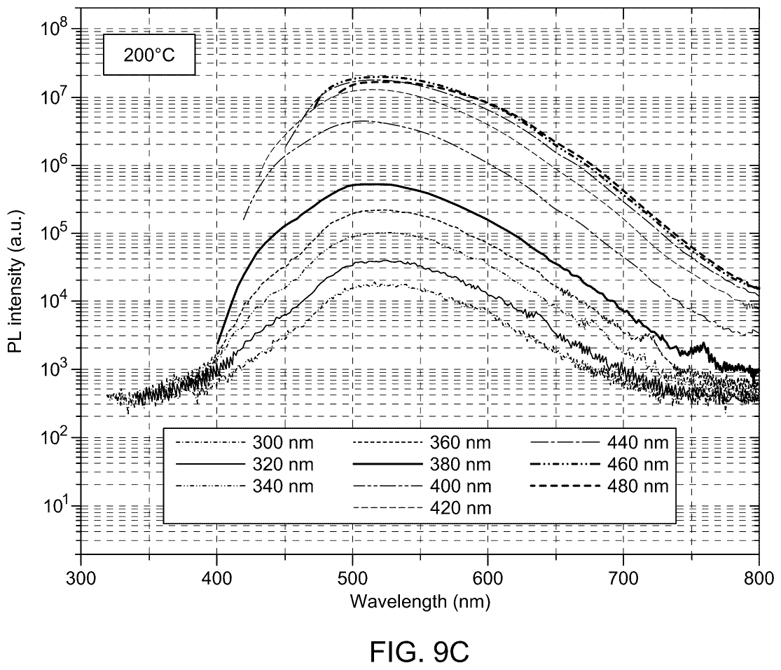

For the determination of the down-conversion/shifting performance, the PL emission spectra were obtained. A wide range of excitation wavelengths (λₑₓ=300 to 480 nm) was used to obtain emission spectra (FIGS. 9A-9C). The PL peak position and Stokes shift are listed in Table 1. The PL peak position is slightly shifted with the variation of the excitation wavelength due to the presence of a defect level. The highest PL intensity was achieved for the excitation wavelength of 480 nm for the CQDs. The obtained fluorescent can be explained on the basis of the Frank-Condon principle, stating that during an electronic transition, a change from one vibrational energy level to another will be more likely to happen if the two vibrational wave functions overlap. The Stokes shift values are compared in Table 2. The Stokes shift obtained for the excitation wavelength of 340 nm are 205.77, 190.51, and 176.94 nm for the synthesis temperatures of 160, 180, and 200° C., respectively.

TABLE 1
Obtained photoluminescence peak position and Stokes
shift at various synthesis temperatures.

| Excitation | | | | | | |
|---|---|---|---|---|---|---|
| wavelength | PL peak position (nm) | | | Stokes shift (nm) | | |
| (nm) | 160° C. | 180° C. | 200° C. | 160° C. | 180° C. | 200° C. |
| 300 | 548.50 | 537.21 | 521.90 | 248.50 | 237.21 | 221.90 |
| 320 | 546.27 | 533.45 | 516.66 | 226.27 | 213.45 | 196.66 |
| 340 | 545.77 | 530.51 | 516.94 | 205.77 | 190.51 | 176.94 |
| 360 | 545.17 | 531.03 | 515.23 | 185.17 | 171.03 | 155.23 |
| 380 | 543.47 | 528.28 | 510.47 | 163.47 | 148.28 | 130.47 |
| 400 | 537.69 | 517.58 | 508.14 | 137.69 | 117.58 | 108.14 |
| 420 | 527.02 | 519.08 | 512.79 | 107.02 | 99.08 | 92.79 |
| 440 | 530.85 | 522.23 | 513.61 | 90.85 | 82.23 | 73.61 |
| 460 | 534.82 | 526.20 | 515.94 | 74.82 | 66.20 | 55.94 |
| 480 | 540.42 | 534.82 | 528.52 | 60.42 | 54.82 | 48.52 |

TABLE 2
Comparison of Stokes shifts of the present disclosure and previous work.

| | | | | | | | | CN107446578(A) | |
|---|---|---|---|---|---|---|---|---|---|
| This work | | | | CN104340965(B) | | | | (FIG. 4) | |
| Excitation | | | | Excitation | | | | Excitation | |
| wavelength | Stokes shift (nm) | | | wavelength | FIG. | FIG. | FIG. | wavelength | |
| (nm) | 160° C. | 180° C. | 200° C. | (nm) | 4 | 9 | 13 | (nm) | |
| 300 | 248.50 | 237.21 | 221.90 | — | — | — | — | 345 | 127 |
| 320 | 226.27 | 213.45 | 196.66 | — | — | — | — | 355 | 119 |
| 340 | 205.77 | 190.51 | 176.94 | 340 | 86.25 | 84.49 | 86.56 | 365 | 110 |
| 360 | 185.17 | 171.03 | 155.23 | 360 | 76.77 | 73.30 | 76.40 | 375 | 102 |
| 380 | 163.47 | 148.28 | 130.47 | 380 | 66.47 | 63.90 | 68.03 | 385 | 95 |
| 400 | 137.69 | 117.58 | 108.14 | 400 | 73.58 | 63.21 | 77.86 | 395 | 87 |
| 420 | 107.02 | 99.08 | 92.79 | 420 | 74.55 | 71.78 | 78.45 | 405 | 82 |
| 440 | 90.85 | 82.23 | 73.61 | 450 | 52.39 | 49.95 | 53.34 | 415 | 84 |
| 460 | 74.82 | 66.20 | 55.94 | — | — | — | — | — | — |
| 480 | 60.42 | 54.82 | 48.52 | — | — | — | — | — | — |

There are several degenerate vibrational levels (υ=0, 1, 2, etc.) for each state (S₀, S₁, S₂, etc.) of the electron. During absorption or emission, the electron can move from any vibrational level of a state to any vibrational level of other states. The transition from υ=0 of the S₀ state to υ=1 of the S₁ state is a favorable Frank-Condon transition.

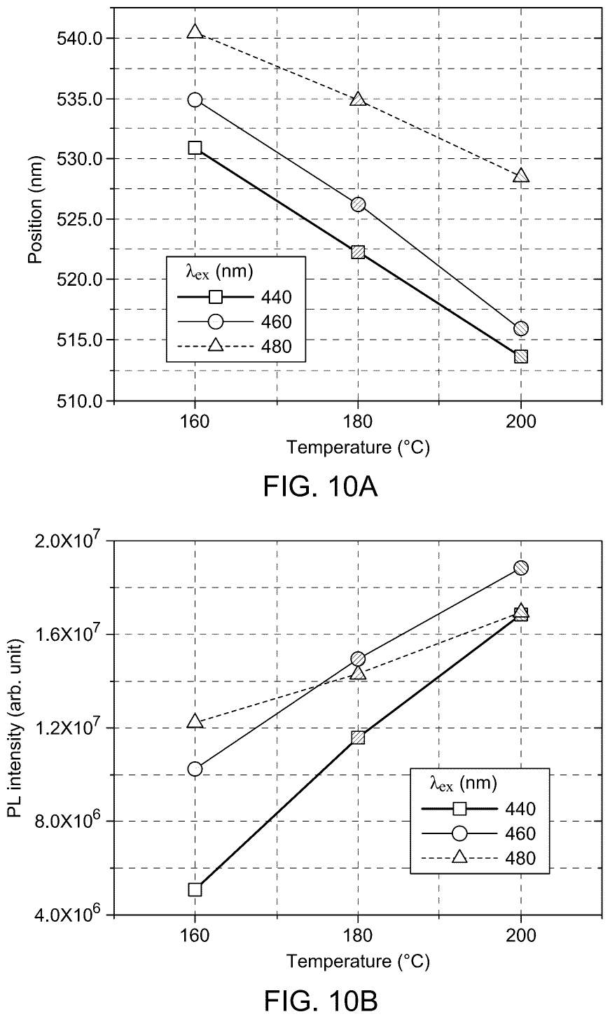

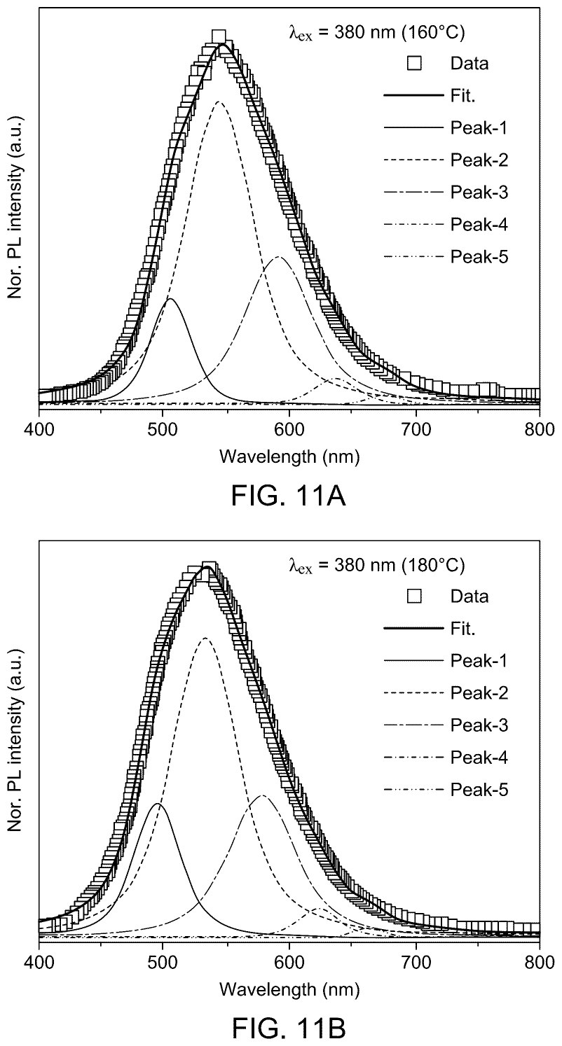

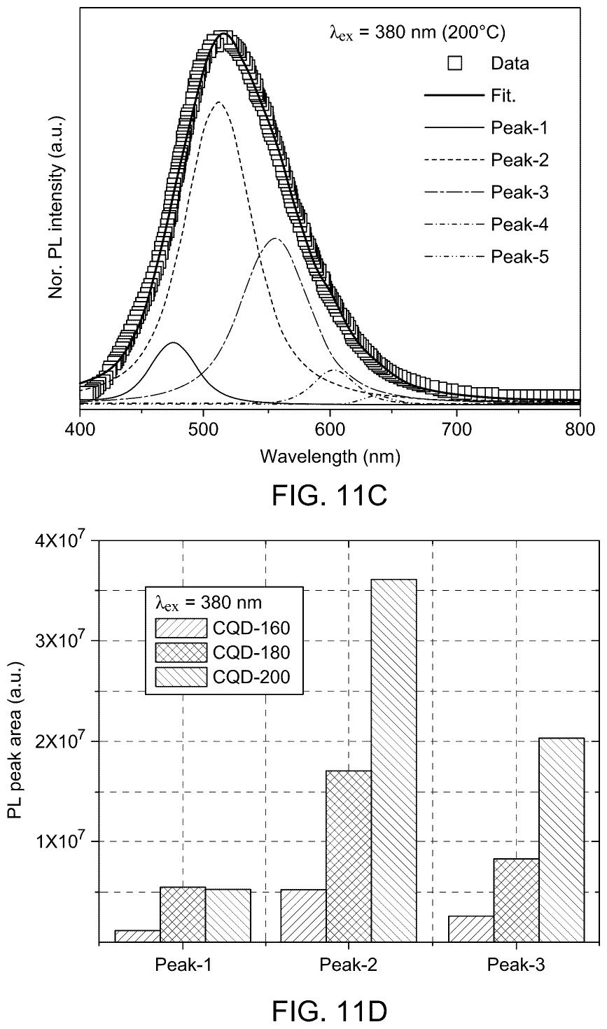

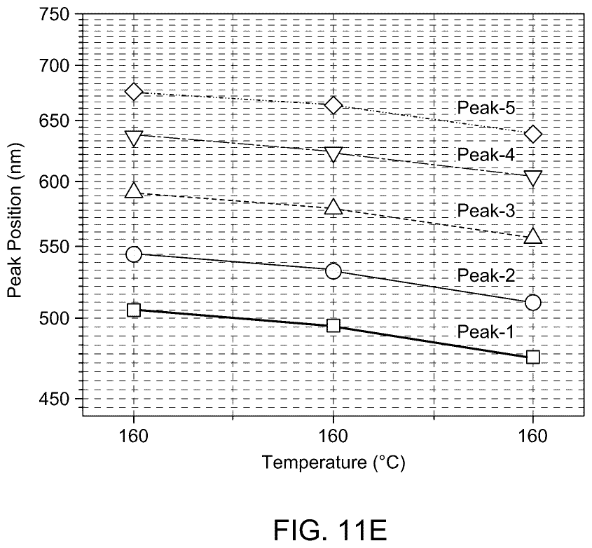

The PL peak position is blueshifted with increasing the synthesis temperature from 160 to 200° C. (FIG. 10A). The blue shifting occurs due to decreasing the size of CQDs with a rise in the synthesis temperature [Hu, C., et. al., Design and fabrication of carbon dots for energy conversion and storage. Chemical Society Reviews, 2019. 48(8): p. 2315-2337]. The TEM results also show the reduction of the size with increasing the synthesis temperature. The PL intensity is increased with an increase in the synthesis temperature (FIG. 10B). The PL emission peaks of all the three CQDs obtained at the excitation wavelength of 380 nm were deconvoluted using Lorentz-Gaussian fit. Each emission peak is deconvoluted into five peaks, however, only three peaks are dominate (FIGS. 11A-11C).

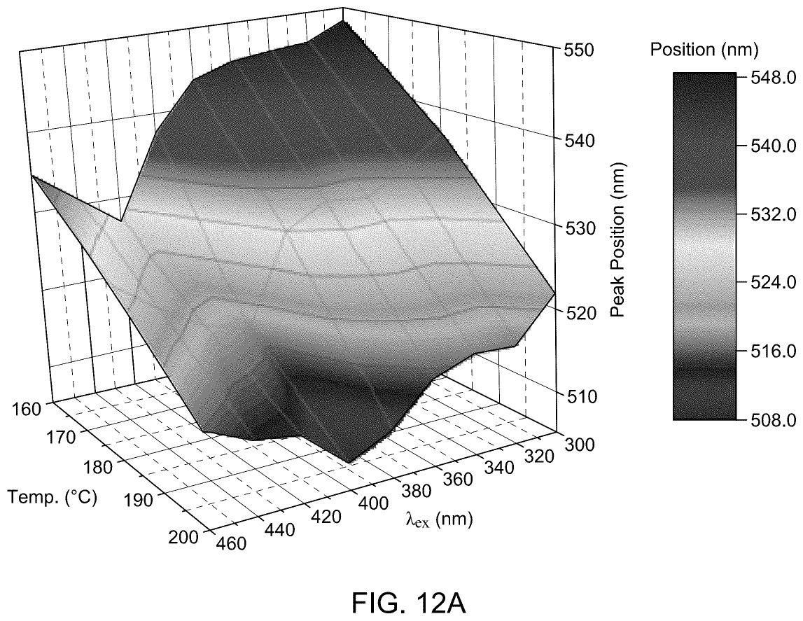

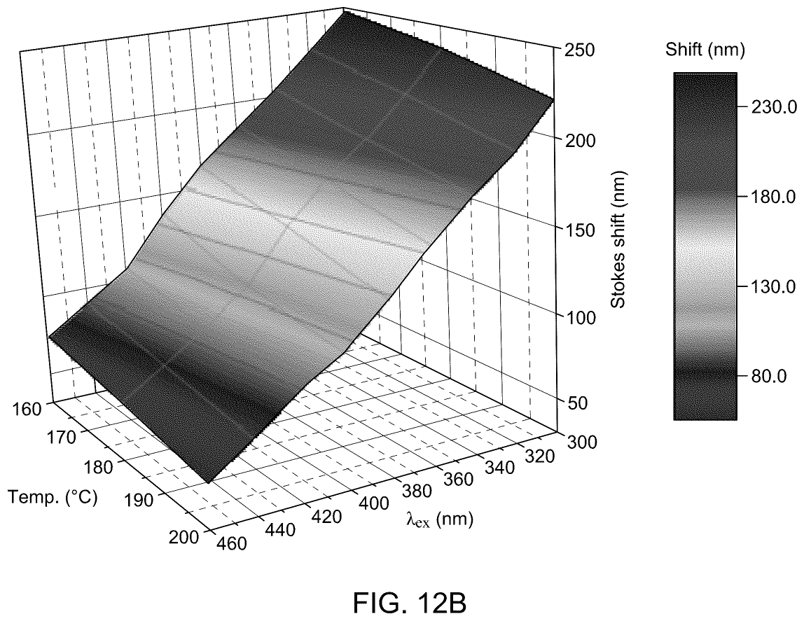

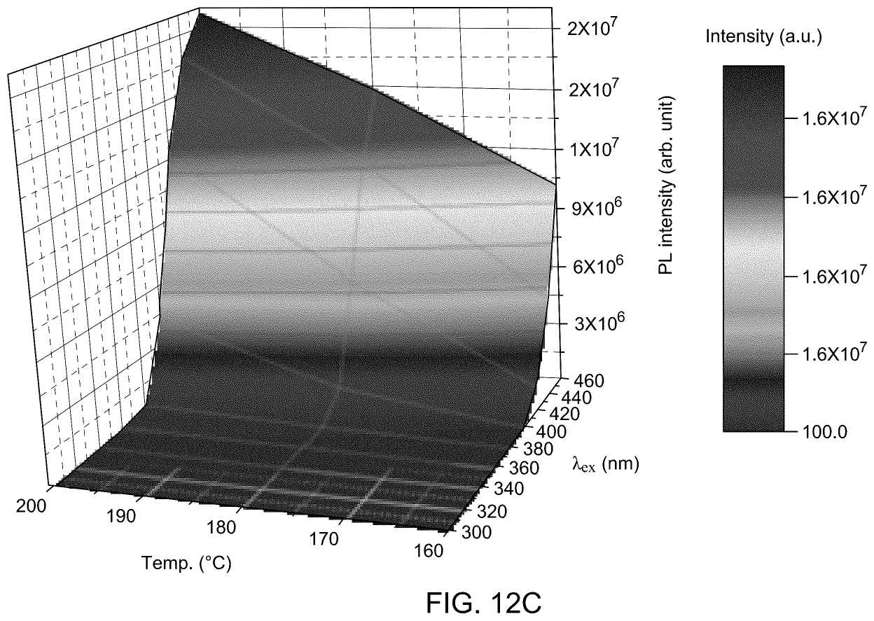

The PL peak area of peak-1 increased with an increase in the synthesis temperature to 180° C., which remained constant for higher temperatures (FIG. 11D). The area of peak-2 and peak-3 gradually increased with the rise in the temperature. The overall peak area is found to be 8.97×10⁶, 3.16×10⁷, and 6.44×10⁷ at an excitation wavelength of 380 nm for CQD-160, CQD-180, and CQD-200, respectively. The PLQY is directly proportional to the PL emission peak area. Thus, it can be concluded that the PLQY of the CQDs is increased by 3.5-fold and 7.2-fold with an increase in the synthesis temperature. The PL peak position blue-shifted with an increase in synthesis temperature (FIG. 11E). The corresponding Stokes shift obtained is 163.5, 148.3, and 130.5 nm at an excitation wavelength of 380 nm for the CQD-160, CQD-180, and CQD-200, respectively. The Stokes shift shrunk with a rise in synthesis temperature. For solar cell applications, the PLQY and Stokes shift are factors to maximize the performance. The Stokes shift obtained here is greater than the Stokes shift reported for graphene quantum dots [Khan, F. and J. H. Kim, N-Functionalized Graphene Quantum Dots with Ultrahigh Quantum Yield and Large Stokes Shift: Efficient Downconverters for CIGS Solar Cells. ACS Photonics, 2018. 5(11): p. 4637-4643; and Khan, F. and J. H. Kim, Emission-wavelength-dependent photoluminescence decay lifetime of N-functionalized graphene quantum dot downconverters; Impact on conversion efficiency of Cu(In, Ga)Se₂ solar cells. Scientific Reports, 2019. 9(1): p. 10803, both of which are incorporated herein by reference in their entireties] and CQDs [Jing, S., et. al., Facile and High-Yield Synthesis of Carbon Quantum Dots from Biomass-Derived Carbons at Mild Conditions. ACS Sustainable Chemistry & Engineering, 2019. 7(8): p. 7833-7843; and Feng, T. et. al., Charge-Convertible Carbon Quantum Dots for Imaging-Guided Drug Delivery with Enhanced in Vivo Cancer Therapeutic Efficiency. ACS Nano, 2016. 10(4): p. 4410-4420, both of which are incorporated herein by reference in their entireties]. For detailed analysis, 3D graphs were plotted, in which two parameters (synthesis temperature and excitation wavelength) are kept along X- and Y-axes, and PL peak position, Stokes shift, and PL intensity are taken along the Z-axis (FIGS. 12A-12C). It can be concluded that the PL emission peak position and Stokes shift are highest for the synthesis temperature of 160° C. and the excitation wavelength of 460 nm. The PL peak intensity is maximum for the synthesis temperature of 200° C. and the excitation wavelength of 460 nm.

To summarize, waste food materials were used as raw materials to synthesize carbon quantum dots using a hydrothermal process at synthesis temperatures of 160, 180, and 200° C. The size of the CQDs is reduced with the rise in the synthesis temperature. The average size of the CQDs is 5.2, 4.8, and 4.3 nm for the synthesis temperature of 160, 180, and 200° C., respectively. The EDS analysis revealed that C, O, Mg, Cl, and K are present in all the CQDs. The CQDs are oxygen-rich, and the atomic percentage of O is 25.75, 23.60, and 25.13% in CQD-160, CQD-180, and CQD-200, respectively. The deconvolution of the absorption spectra suggests that four transitions are involved in the wide absorption of the CQDs. The PL emission peak position is blueshifted with the rise in temperature. The Stokes shift is also increased with a reduction in the synthesis temperature; however, the integrated PL peak area increased with increasing temperature. The peak area increased by 3.5-fold and 7.2-fold for the rise in the temperature from 160 to 180° C. and from 160 to 200° C., respectively. This result revealed that the PLQY can be enhanced by 3.5 and 7.2 times for an increase in temperature from 160 to 180° C. and from 160 to 200° C., respectively.

Numerous modifications and variations of the present disclosure are possible in light of the above teachings. It is therefore to be understood that within the scope of the appended claims, the disclosure may be practiced otherwise than as specifically described herein.

1: A method for synthesizing carbon quantum dots, comprising:
reacting a mixture of a fruit waste material and deionized water hydrothermally in an autoclave at a reaction temperature in a range of 150° C. to 250° C. to form a carbon quantum dot containing suspension;
centrifuging the carbon quantum dot containing suspension to separate the carbon quantum dots from a hydrochar; and
filtering the carbon quantum dot containing suspension to obtain the carbon quantum dots,
wherein the carbon quantum dots have a size ranging from 2 to 10 nm,
wherein the carbon quantum dots have a Stokes shift of at least 150 nm at an excitation wavelength of 360 nm or lower.

2: The method of claim 1, further comprising:
drying the fruit waste material before reacting the mixture of fruit waste material and deionized water.

3: The method of claim 1, wherein the reacting occurs for at least 24 hours.

4: The method of claim 1, wherein filtering the carbon quantum dot containing suspension comprises passing the carbon quantum dot containing suspension through a filter with a pore size of 0.22 μm.

5: The method of claim 1, wherein the fruit waste material is a canary melon.

6: The method of claim 1, wherein the fruit waste material is the skin of a canary melon.

7: The method of claim 1, wherein the reacting is carried out at the reaction temperature in a range of 160° C. to 200° C. and forms carbon quantum dots having a crystallite size from 0.5 to 1.5 nm.

8: The method of claim 1, wherein the reacting is carried out at the reaction temperature in a range of 160° C. to 200° C. and forms carbon quantum dots having a d-spacing value of 3.5 to 4.5 nm.

9: The method of claim 1, wherein the reacting is carried out at the reaction temperature in a range of 160° C. to 200° C. and forms carbon quantum dots having an average height of 0.2 to 0.4 nm.

10: The method of claim 1, wherein the reacting is carried out at the reaction temperature in a range of 160° C. to 200° C. and forms carbon quantum dots having a diameter ranging from 4 to 6 nm.

11: The method of claim 1, wherein the reacting is carried out at the reaction temperature in a range of 160° C. to 200° C. and forms carbon quantum dots having carbon in an amount of 50 to 65 at. %, oxygen in an amount of 24 to 38 at. %, sodium in an amount of 0.5 to 3 at. %, magnesium in an amount of 0.5 to 3 at. %, chloride in an amount of 0.5 to 5 at. %, and potassium in an amount of 2 to 10 at. % based on a total atom count of the carbon quantum dots.

12: The method of claim 1, wherein the reacting is carried out at the reaction temperature in a range of 160° C. to 200° C. and forms carbon quantum dots having a UV-visible absorption spectra signal in a 250 to 400 nm wavelength range.

13: The method of claim 12, wherein the UV-visible absorption spectra signal comprises a first peak from 295 to 302 nm, a second peak from 303 to 310 nm, a third peak from 318 to 320 nm, and a fourth peak from 335 to 340 nm.

14: The method of claim 12, wherein the UV-visible absorption spectra signal has a total peak area of 30 to 65 au.

15: The method of claim 1, wherein the reacting is carried out at the reaction temperature in a range of 160° C. to 200° C. and forms carbon quantum dots having a UV-visible emission spectra signal in a 450 to 800 nm wavelength range at an excitation wavelength of 300 to 480 nm.

16: The method of claim 15, wherein the UV-visible emission spectra signal comprises a first peak from 470 to 510 nm, a second peak from 500 to 550 nm, a third peak from 550 to 600 nm, a fourth peak from 600 to 650 nm, and a fifth peak from 650 to 670 nm.

17: The method of claim 15, wherein the UV-visible emission spectra signal has a peak area from 0.8×10⁷ to 7.0×10⁷ at an excitation wavelength of 380 nm.

18: The method of claim 1, wherein the reacting is carried out at a reaction temperature of 180° C. to form carbon quantum dots having a photoluminescence quantum yield that is 3- to 4-fold greater than the photoluminescence quantum yield of the carbon quantum dots formed at the reaction temperature of 160° C.

19: The method of claim 1, wherein the reacting is carried out at a reaction temperature of 200° C. to form carbon quantum dots having a photoluminescence quantum yield that is 7- to 8-fold greater than the photoluminescence quantum yield of the carbon quantum dots formed at a reaction temperature of 160° C.

20: The method of claim 1, wherein the reacting is carried out at the reaction temperature in a range of 160° C. to 200° C. and forms carbon quantum dots having a Stokes shift from 220 to 250 nm at an excitation wavelength of 300 nm.
